(19) United States
(12) Patent Application Publication
(10) Pub. No.: US 2004/0218760 A1
(43) Pub. Date: Nov. 4, 2004

(54) System and method for data encryption and compression (encompression)

(76) Inventor: Parimal Pal Chaudhuri, Kolkata (IN)

Correspondence Address: BAKER BOTTS L.L.P., 2001 ROSS AVENUE, SUITE 600, DALLAS, TX, 75201-2980, US

(21) Appl. No.: 10/749,024

(22) Filed: Dec. 30, 2003

Related U.S. Application Data
(60) Provisional application No. 60/437,886, filed on Jan. 3, 2003.

(51) Int. Cl. H04N 7/167

(52) U.S. Cl. 380/217

(57) ABSTRACT

In one embodiment, a method of encompressing a data stream includes compressing vectors from the data stream using (e.g., transformed with) one or more Multiple Attractor Cellular Automatas (MACAs) and encrypting the compressed vectors using multiple Cellular Automata (CA) transforms. In another embodiment, a system for encompressing a data stream includes a Programmable CA (PCA) operable to receive vectors from the data stream, a program memory and an index memory each operable to communicate with the PCA, and an index register operable to communicate with the index memory. The program memory stores a program that is operable to configure the PCA with a rule vector of a CA and enable the PCA to be run through a number of cycles controlled by the program, a resulting Pseudo-Exhaustive Field (PEF) value being directed to address the index memory. The index memory provides values to the index register, enabling a code-book index to be generated for a token loaded into the PCA.

### RELATED APPLICATION

This application claims priority under 35 U.S.C. § 119(e) of provisional application serial No. 60/437,886 filed Jan. 3, 2003.

### TECHNICAL FIELD

The present invention relates to efficient and secured storage and transmission of digital data files and, more particularly, to a system and method that implements encryption and compression operations as a fully integrated single operation using a computing model based on Cellular Automata (CA).

### BACKGROUND

In the current Internet age, large volumes of data, including text, image, graphics, video, and audio files, are stored and transferred over communication links. The communication links may include copper wires, Ti lines, coaxial cable, wireless channels, or the like. In general, such communication links are bandwidth limited. In addition, computer memory storage capacity is typically a concern. As a result, efficient storage and transmission of voluminous data along with adequate data security is increasingly important. Design of high speed, low cost hardware for on-line applications is desirable to satisfy this need.

Traditionally, data compression and data encryption have been implemented as two discrete operations employing two diverse technologies. This has increased the complexity of encryption and compression techniques and the time necessary to execute the encryption and compression operations.

A CA is a type of computing model involving an array of “cells” that interact locally with one another. Each of the cells can be in one of the two binary states ‘0’ or ‘1.’ The binary string of cell states constitute the state of the CA. The CA state changes over time. The number of possible CA states depends on the number of cells—that is, an n cell CA can be in one of 2ⁿ possible states. A cell's next state is based on its own current state, and that of its neighboring cells. In a one-dimensional CA, the next state of ith cell depends on the current state of (i−1)^{th}, i^{th}, and (i+1)^{th} cells. The next state logic of a cell specifies its rule number. The CA rule vector R=<R₁, R₂.,Rᵢ, . . . Rₙ> of an n cell CA is a vector of n rules where R₁ denotes the rule for the ith cell. A CA rule vector R specifies the structure of the CA and consequently, it globally maps the current state to next state CA evolution with time. It is known to use CA-based technology to perform data encryption and compression as two discrete operations.

### SUMMARY OF THE INVENTION

According to the present invention, disadvantages and problems associated with previous encryption and compression techniques may be reduced or eliminated.

In one embodiment, a method for encompressing a data stream includes compressing vectors from the data stream using (e.g., transformed with) one or more Multiple Attractor CAs (MACAs) and encrypting the compressed vectors using multiple CA transforms.

In another embodiment, a system for encompressing a data stream includes a Programmable CA (PCA) operable to receive vectors from the data stream, a program memory and an index memory each operable to communicate with the PCA, and an index register operable to communicate with the index memory. The program memory stores a program that is operable to configure the PCA with a rule of a CA and enable the PCA to be run through a number of cycles controlled by the program, a resulting value being directed to address the index memory. The index memory provides values to the index register, enabling a code-book index to be generated for an input vector loaded into the PCA.

Particular embodiments of the present invention may provide one or more technical advantages. For example, in certain embodiments, the present invention provides a system and method that supports both encryption and compression through efficient compression of specific classes of data files while ensuring a high level of data security. In certain embodiments, data encryption and compression operations are implemented as a fully integrated single operation, which may be referred to as “Encompression,” using a CA-based computing model. Accordingly, the process implemented according to certain embodiments may be referred to as CA-Encompression (CAE). In one embodiment, the process accepts a digital data file as input and outputs an encompressed file that can be stored and/or transferred from a source over a communication link. At the destination, the file can be decrypted and decompressed in a single operation, which may be referred to as “D'encompresssion,” to restore the original data. The Encompression process may help ensure secure and efficient storage and communication of digital data files. The process can be implemented in any suitable combination of software and hardware employing a CA-based computing model.

In certain embodiments, the computing model has a structure referred to as a PCA that can be programmed to encompress (i.e. encrypt and compress) specific classes of data files. Different classes of data files may require different programs that operate on the PCA structure. The PCA program may include a set of instructions, each of which specifies the CA rule vector with which the PCA is configured and the number of time steps the configured CA is operated, in addition to an optional tag field.

In one embodiment, Encompression of an input file using the CA-based Encompression algorithm and D'encompression of the encompressed file using the CA-based D'encompression algorithm are performed using Encompression and D'encompression programs, respectively. In one embodiment, the PCA program for Encompression and D'encompression configures the PCA in different steps as (i) maximum length group CA, (ii) non-maximum length group CA, (iii) non-group CA, and (iv) non-linear CA. In effect, in certain embodiments, a series of CA transforms are derived out of different CA configurations in different steps of the PCA program operated on the PCA structure.

Certain embodiments of the present invention may provide all, some, or none of the above technical advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and features and advantages thereof, reference is now made to the following description, taken in conjunction with the accompanying drawings, in which:

FIG. 1(a) is a block diagram illustrating a high-level Encompression and D'encompression architecture;

FIG. 1(b) is a block diagram illustrating the architecture of an example Encompression module of FIG. 1(a);

FIG. 1(c) is a block diagram illustrating the architecture of an example D'encompression module of FIG. 1(a);

FIG. 2 is an example state transition diagram of a maximum length group CA;

FIG. 3 is an example state transition diagram of a non-maximum length group CA;

FIG. 4 illustrates the structure and state transition behavior of an example four cell non-group CA (also referred to as Multiple Attractor CA (MACA));

FIG. 5 is a block diagram illustrating the logical structure of an example MACA-based multi-stage two-class classifier;

FIG. 6 is a block diagram illustrating the logical structure of an example encoder and decoder; and

FIG. 7 is a block diagram illustrating the encryption scheme integrated in an example Encompression algorithm.

### DESCRIPTION OF EXAMPLE EMBODIMENTS

In certain embodiments, the present invention provides secured efficient storage and/or transmission of digital data. In certain embodiments, the system and method of the present invention implement data encryption and compression operations as a fully integrated single operation employing a computing model based on CA. As a result, the process employed by the present invention may be referred to hereafter as “CA-Encompression” (CAE) or merely “Encompression.” Implementation of Encompression and D'encompression (the reverse of Encompression) operations based on CA technology are detailed in the following subsections.

I. CAE

Encompression may be either lossy or lossless. While in lossy Encompression a D'encompressed data file closely matches the original data, in lossless Encompression a D'encompressed data file exactly matches the original data file. Unless stated otherwise, the systems and methods described hereafter may be applied for either type of encompression—lossy or lossless. Encompression of a class of data file is accomplished through a code-book specific to the class. Different code-books may be generated for different classes of data files.

A. Code-Book and Code-Vectors

The Encompression function operates on a specific class of data file such as human portrait, MRI medical image, etc. Domain knowledge of that specific class of data file is extracted from a representative set of data files to form a corresponding code-book. The representative set of data files may be referred to as a “training set.” A code-book contains a set of vectors referred to as code-vectors. A vector specifies a set of elements, each representing a physical quantity such as a pixel value in an image data file, a digitized signal value in a voice data file, character(s) in a text file, or other suitable quantities. As explained in greater detail below, a code-vector in the code-book represents the centroid of the cluster of a set of vectors that are close to each other in terms of the value of the elements the cluster represents. All the vectors in a cluster are within a specified threshold distance from its centroid represented as a code-vector in the code-book. A vector of any arbitrary data file (of the class) to be encompressed is represented by a code-vector in the code-book if its distance is less than the threshold distance. Consequently, compression is achieved through representation of the vector by the index of the corresponding code-vector in the code-book. The set of such indices form the encompressed file subsequent to its encryption. For D'encompression, the code-book is assumed to be available at the receiving end. The original code-vector is retrieved from the code-book using the decrypted index.

B. Processing of Vectors Outside The Threshold Limit of A Cluster Built Around Its Centroid

As described above, a cluster of vectors is represented by its centroid that is recorded as a code-vector in the code-book. In one embodiment, a vector outside the threshold distance of a code-vector (with which its distance is less than any other code-vector) is processed according to the following steps.

i. Lossy Encompression

For lossy Encompression, at a first step, the difference between the input vector and the centroid of the cluster is determined. The difference may be referred to as an error vector (EV). At a second step, the EVs are transformed in frequency domain and are represented through encoding of transform coefficients. Thus, an input vector (of a file to be encompressed) may be represented by the index of the code vector in the code-book, followed by the encoded value of transform coefficients.

ii. Lossless encompression For lossless Encompression, the EV may be differentially encoded with reference to the code-vector of the code-book. Both the Encompression and D'encompression modules may be implemented either with software routine and/or hardware circuit. These two modules are described below in next two sub-sections.

C. The Encompression Module

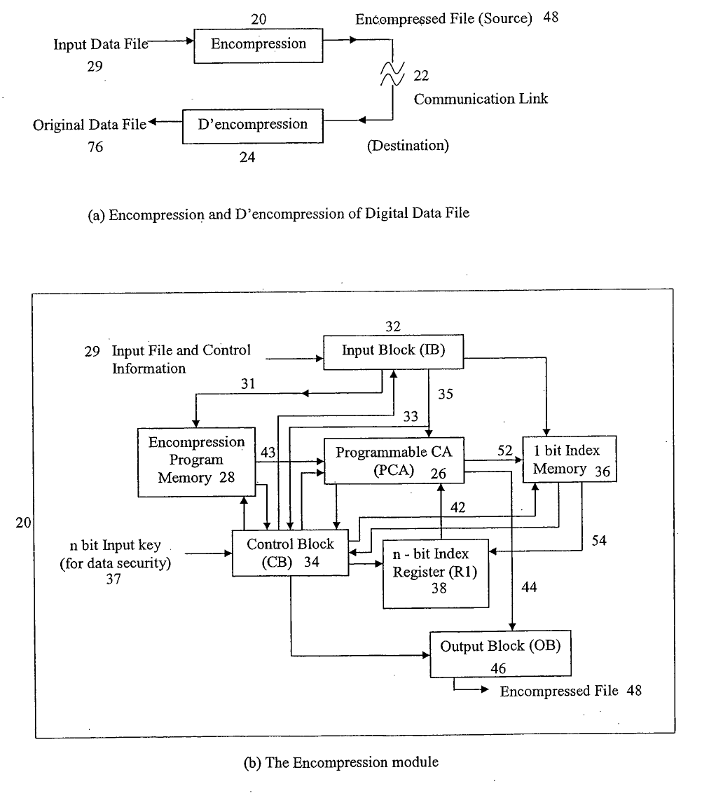

FIG. 1(a) is a block diagram illustrating a high-level Encompression and D'encompression architecture. As illustrated in FIG. 1(a), an Encompression module 20 accepts an input data file 29 and outputs a corresponding encompressed file 48 that can be stored or transmitted over a communication link 22. In order to restore the original data, the process of D'encompression may be implemented at the destination via a D'encompression module 24.

FIG. 1(b) is a block diagram illustrating the architecture of an example Encompression module 20 of FIG. 1(a). Encompression module 20 includes a PCA 26 with its program stored in a program memory 28. Program memory 28 may store the Encompression program, which consists of two Program Blocks—Program Block 1 and Program Block 2. Program Block 1 and Program Block 2 are described in more detail below. An example procedure for development of the Encompression program is described below in Section II.

In one embodiment, a different Encompression program is developed for each class of input data file. Each step of the Encompression program may specify the CA rule with which PCA 26 is configured and the number of cycles the PCA is operated once it is configured with the specified CA rule. “Control information” may be input to Encompression module 20 along with the input data file, as indicated at 29 in FIGS. 1(a) and 1(b). A vector refers to a data block of the input file to be processed by Program Block 1 of the Encompression process at one time step. Variable size vectors may be processed by the Encompression process. In one embodiment, the number of PCA cells in PCA 26 is greater than the number of bits in a vector.

As illustrated in FIG. 1(b), an input block (labeled IB) 32 may accept an input file 29, the relevant control information, and the Encompression program developed for the file type. In one embodiment, as indicated by arrows 31, 33, and 35 respectively, input block 32 transfers the Encompression program to the program memory 28, control information to a control block (labeled CB) 34, and initializes the PCA cells of PCA 26 with a vector. As illustrated at 37, control block 34 may also accept an input key. Input file 29 may be encrypted with an n bit input key for data security. The value n may vary depending on the requirements of the specific application. However, in one embodiment, n should be less than or equal to the number of cells available in PCA 26.

Encompression module 20 also includes (i) an index memory 36, which may be 1-bit for example; and (ii) an index register (labeled R1) 38, which may be n bits. As described in more detail below, a Pseudo-Exhaustive Field (PEF) of an attractor of a CA basin may generate the address for index memory 36. Register 38 may store the index of the code-vector in the code-book generated using the index memory 36 at successive program steps of operation of PCA 26. That is, as described in more detail below, the index memory 36 and register 38 may be used to develop the bit string of an index value of the code-vector in the code-book that best matches the input vector. In one embodiment, a set of input vectors may be processed until the register 38 is filled.

In one embodiment, the execution of the Encompression process is controlled by control block 34. As indicated by arrow 43, Program Block 1 of the Encompression program may operate on PCA 26 loaded with an input vector 35 from input block 32. PCA 26, as indicated by arrow 42, may be loaded with the data from register 38 after execution of Program Block 1. As indicated by arrow 44, after execution of the Program Block 2 on PCA 26, the encompressed data (corresponding to a set of input vectors) may be sent to an output block (labeled OB) 46 from the final state of PCA 26. The sequence of output vectors in output block 46 makes up an Encompressed file 48.

D. CA-Based Encompression (CE) Algorithm

The CE algorithm executed by Encompression module 20 is described below. In one embodiment, the inputs to the CE algorithm include:

(1) a data file to be encompressed;

(2) control information related to vector size, data class type;

(3) an Encompression program for the specific data class type; and

(4) an n bit key to be employed for data security.

The output of the CE algorithm is encompressed file 48. In one embodiment, the steps of the CE algorithm executed by Encompression module 20 are as follows.

Step 1: Input block 32 transfers the control information to control block 34 and the Encompression program to program memory 28. Control block 34 may also store the input key and control each of the subsequent steps of the CE algorithm.

Step 2: Input block 32 transfers a vector from the input file to PCA 26.

Step 3: PCA 26 is configured with the program step (i.e. the CA rule) of Program Block 1 and operated for the number of cycles specified by the program step of Program Block 1.

Step 4: PCA 26 generates an output, which may be an attractor state. The PEF bits of the attractor may be the address for index memory 36, as indicated by arrow 52.

Step 5: In successive program steps, the content of index memory 36 (described above in step 4) may be transferred to register 38, as indicated by arrow 54, to develop the index of the code-vector in the code-book that has best matches the vector.

Step 6: Steps 3 through 5 may be repeatedly executed until register 38 (e.g., having n bits) is filled. In one embodiment, the key size is assumed to be n.

Step 7: PCA 26 may be re-initialized with the data in register 38.

Step 8: Program Block 2 may be executed on PCA 26.

Step 9: The final state of PCA 26 may be sent to output block 46.

Step 10: Steps 2 through 9 may be repeatedly executed until all the vectors in the input file are processed. As a result, output block 46 may generate Encompressed file 48.

E. The D'encompression Module

In order to restore the original data file, a D'encompression process may be performed by D'encompression module 24 illustrated in FIG. 1(a). FIG. 1(c) is a block diagram illustrating the architecture of an example D'encompression module 24 of FIG. 1(a). D'encompression module 24 includes a PCA 62, program memory 64, control block (labeled CB) 66, register (labeled R2) 68, and a memory 72, which may be referred to as code-book memory 72. Code-book memory 72 may store the one or more code-books used to generate the Encompression program.

As illustrated at arrow 48, a D'encompression input block (labeled IB) 74 may accept the code-book, encompressed file, control information (e.g., regarding the file type and vector size), the D'encompression program, and the key employed for Encompression. The D'encompression program may be stored in program memory 64. In one embodiment, the D'encompression may be substantially similar to Program Block 2 of the Encompression program but with the sequence of program steps reversed. Control block 66 may sequentially execute the D'encompression program to restore the original file. Example algorithmic steps for D'encompression are next reported.

F. D'encompression (DE) Algorithm

The DE algorithm executed by D'encompression module 24 is described below. In one embodiment, the inputs to the DE algorithm include:

(1) an Encompressed file (i.e. Encompressed file 48);

(2) control information regarding file type, vector size, etc;

(3) one or more code-books;

(4) the D'encompression program; and

(5) the key used for Encompression.

The output of the DE algorithm is original data file 76. In one embodiment, the steps of the DE algorithm executed by D'Encompression module 24 are as follows.

Step 1: Input block 74 may distribute: (i) the received Encompressed file (i.e. Encompressed file 48) and D'encompression program to program memory 64, as indicated by arrow 82; (ii) the one or more received code-books to code-book memory 72, as indicated by arrow 84; and (iii) the received control information to control block 66, as indicated by arrow 86. Input block 74 may also set the required size of PCA 62 with a key size of n bits as indicated by arrow 88.

In one embodiment, the following steps 2 through 5 are executed for each n-bit block of data of the compressed file.

Step 2: The program steps of the D'encompression program are executed from the program memory 64, by configuring PCA 62, loading it with an n-bit data block from encompressed file, and running it for a number of cycles specified in a program step for example.

Step 3: As a result of execution of the D'encompression program, output of PCA 62 may be stored in register 68, as indicated by arrow 92. The output of PCA 62 may include a sequence of memory addresses for code-book memory 72.

Step 4: Under the control of control block 66, the data of register 68 (i.e. the output of PCA 62) may be used to access code-book memory 72, as indicated by arrow 94, to retrieve the original, D'encompressed vectors of the original data file.

Step 5: As indicated by arrow 98, the D'encompressed file is built in an output block (labeled OB) 96, by extracting the data from code-book memory 72 for example.

For additional information and details regarding the PCAs 26 and 62, reference is made to Section 7 of a paper entitled “A Pipeline Architecture For Encompression (Encryption+Compression) Technology,” Chandrama Shaw, Debashis Chattedjee, Pradipta Maji, Subhayan Sen, B. N. Roy, and P. Pal Chaudhuri, IEEE VLSI Design Conference, New Delhi, India, January 2003, which is hereby incorporated by reference.

II. Example Details and Example Operation of Encryption and D'encryption Programs

This section describes example details and example operation of the encryption and d'encryption programs used by Encompression module 20 and D'encompression module 24, and the CE and DE algorithms discussed in connection therewith. Encompression of an input file using the CE algorithm and D'encompression of the encompressed file using the DE algorithm may be performed using the program blocks, Program Block 1 and Program Block 2, described below.

Different classes of CA employed in the program blocks include linear CA, additive CA, and non-Linear CA. Each class of CA can be divided into group CA and non-group CA. A group CA can be further sub-divided as a maximum length or a non-maximum length group CA. In one embodiment, the next state logic employed by linear CA and additive CA includes a linear logic circuit having an exclusive-OR (XOR)/exclusive-NOR (XNOR) logic function. In particular, linear CA uses XOR logic, while additive CA uses both XOR and XNOR logic. A linear CA may be modeled with its characteristic T-matrix. An additive CA may be represented by both a T-matrix and an inversion vector F. In one embodiment, if XOR (XNOR) logic is employed for the i^{th} cell, the i^{th} element of the F vector is 0(1).

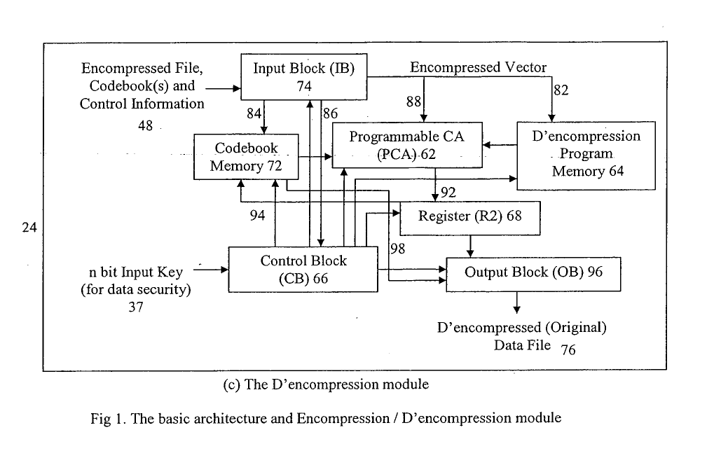

FIG. 2 is an example state transition diagram of a maximum length group CA. The numbers noted within the circles represent states of the CA. In one embodiment, if all the states of the state transition diagram of a CA lie in one or more cycles, such as the state transition diagram illustrated in FIG. 2, the CA is a group CA. An n-cell maximum length CA is characterized by the presence of a cycle of length (2**n-1) with all nonzero states. For the maximum length group CA illustrated in FIG. 2, n=4; thus, the cycle length is fifteen.

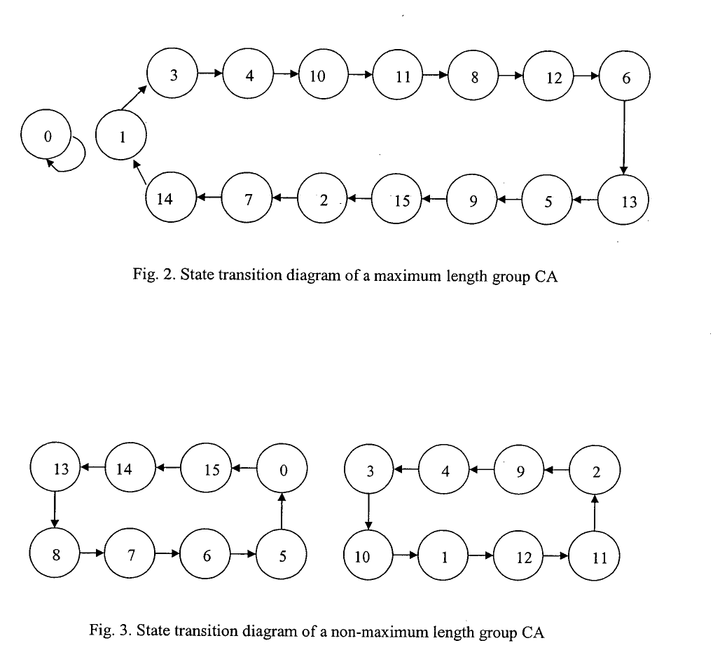

FIG. 3 is an example state transition diagram of a non-maximum length group CA. In contrast to the maximum length group CA, the non-maximum length group CA may have more than one cycle in its state transition diagram. For example, the non-maximum length group CA may have cycles of a length less than the maximum length value (i.e. less than 2**n-1 for an n-cell CA).

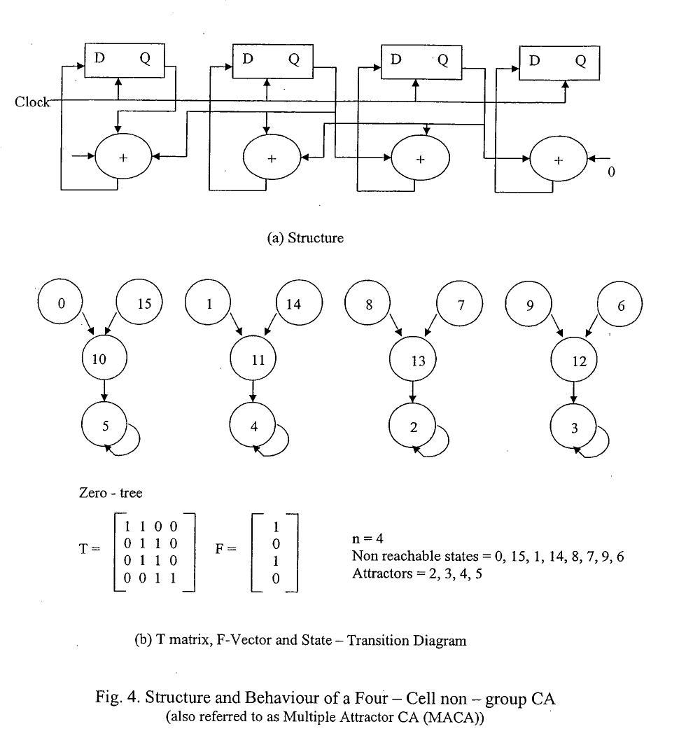

FIG. 4 illustrates the structure and state transition behavior of an example four cell non-group CA (also referred to as a Multiple Attractor CA (MACA)). In one embodiment, a non-group CA may have some states that are non-reachable. For example, the non-group CA illustrated in FIG. 4 has the special property that its state space is divided into multiple attractor basins, each basin forming an inverted tree with its single cycle attractor. Each of the attractors (i.e. of a K-attractor MACA) and its basin may be uniquely identified by a log₂K PEF of the attractor states. For example, the states 5, 4, 2, 3 are the attractor states in the non-group CA illustrated in FIG. 4 that have the last two bits as the PEF bits. The non-group CA illustrated in FIG. 4 also has four attractor basins and consequently, it may be referred to as an MACA. In one embodiment, an MACA may act as a natural classifier. In addition to linear and additive CA and group and non-group CA, the Encompression and D'encompression programs and modules may also use non-linear group CA using non-linear logic with AND, OR, and NOT logic functions.

Program Block 1

Prior to executing the Encompression process, a code-book may be generated as described below in section III and in detail in sections 4.1.1 and 4.1.2 of the paper entitled “A Pipeline Architecture for Encompression (Encryption+Compression) Technology,” attached as Appendix 1. The code-book may be used to generate the Encompression program. The code-book may be kept on the receiver side of the communication link 22.

A code-book may include a collection of code-vectors. Each code-vector may be the centroid of a cluster of vectors that are close to each other in respect to the value of the elements they represent. For lossy Encompression, a vector may be represented by the code-vector that the vector best matches. A vector on compression may be represented by the index of the code-vector and transform coefficients as described above in section I(A). For lossless Encompression, the input vector may be represented by the index and encoded value of its difference with the code-vector with which it has minimum distance.

For each vector of the input file, it may be desirable to identify the code-vector that is the closest match. In one embodiment, Program Block 1 implements this search function in the code-book. A set of MACAs may be employed as implicit memory to represent the code-book.

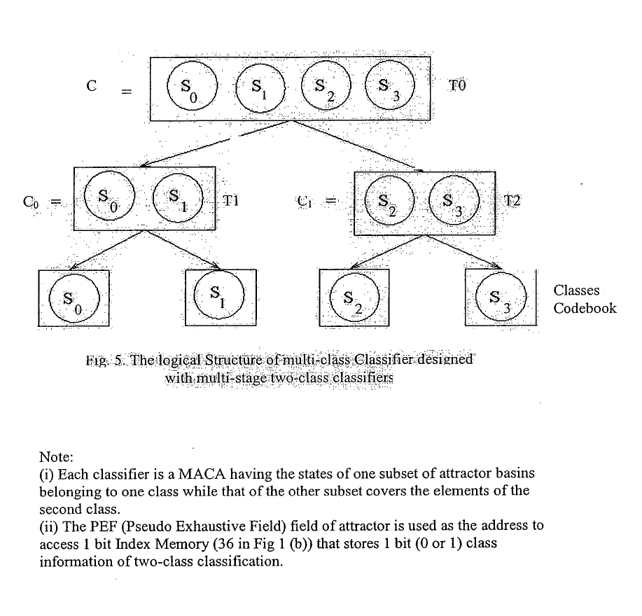

FIG. 5 is a block diagram illustrating the logic structure of an example MACA-based multi-stage two-class classifier. In one embodiment, Program Block 1 uses multi-stage two-class MACAs to create a multi-class classifier. Program Block 1 may classify a vector from the input file into one of the clusters represented by their respective centroids stored as code-vectors in the code-book. This functionality may be implemented in multiple stages as illustrated by the logic structure of the MACA in FIG. 5. In FIG. 5, a vector may be input to the top-most level (T0) of the logic structure. The vector may be classified by a two-class MACA into one of the two classes (T1 or T2) of the code-book. The process may be repeated at the next lower level of the logic structure of FIG. 5, with two MACAs for classifying the elements of T1 and T2 such that the vector is classified in one of the four classes. As the input vector is classified in successive levels of FIG. 5, the PEF of the attractor of the MACA basin may be extracted from PCA 26 and passed to access the index memory 36. The sequence of bits generated from index memory 36 may be collected in register 38 as the input vector traverses the multi-class classifier of FIG. 5, generating the index for the code-book. The input vector may have a best match with the code-vector addressed by this index in the code-book.

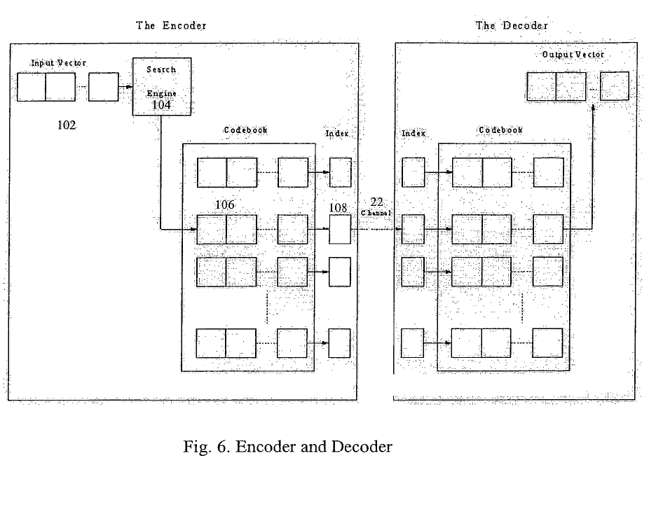

FIG. 6 is a block diagram illustrating the logical structure of an example encoder and decoder. In one embodiment, the MACAs used by Program Block 1 are designed such that the vector may be classified into the class or “cluster” of the closest code-book entry, as described below in section III and in section 4 of the paper entitled “A Pipeline Architecture for Encompression (Encryption+Compression) Technology.” As a result, the MACAs may act as the encoder of FIG. 6. For example, the vector may be input at 102, and the MACAs may act as a search engine 104 such that the vector is matched to the closest code-book entry 106 and the corresponding index 108 is obtained (e.g., in register 38 in FIG. 1(b)). The index values generated for a set of vectors of the input file may be concatenated in register 38. PCA 26 may be initialized with content of register 38 (FIG. 1(b)), which may be transformed by Program Block 2 (as described below) and transferred to the output block 46 for transmission across communication link 22.

Program Block 2

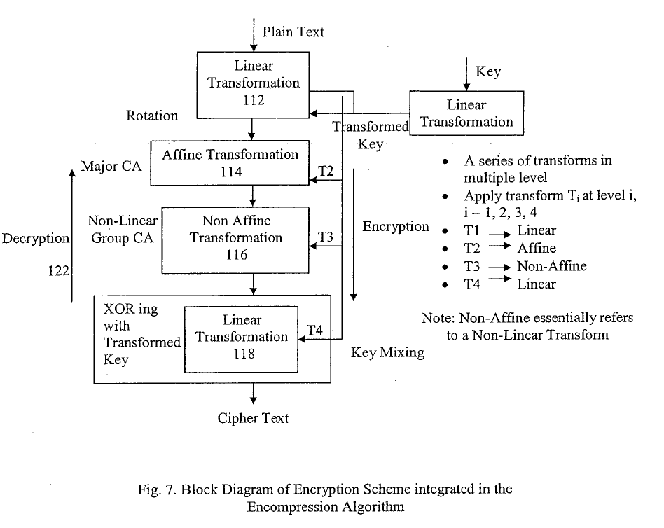

The indices of the code-book may be encrypted using multiple CA transforms. In one embodiment, the encryption performs a series of reversible transforms on the content of PCA 26 received from register 38 to arrive at a cipher text. FIG. 7 is a block diagram illustrating the encryption scheme integrated in an example Encompression algorithm. As illustrated in FIG. 7, four levels of CA-based transforms may be used in the encryption process.

Introducing a series of transforms (e.g., simple, moderately complex, and complex) may help achieve a desired level of security with minimum cost and high-speed execution. The transform at each level may be dependent on some function of the input key (e.g., key 37). In one embodiment, the length of the key is varied to exploit the modular and cascadable structure of CA.

In one embodiment, a first level 112 of encryption is a linear transform of the input key and of plain text, the linear transform of the plain text being implemented by rotating each bit of the value in PCA 26. At a second level 114 of encryption, an affine transform may be introduced with an additive CA. A non-affine transformation 116 may be implemented by employing a non-linear reversible CA. A linear transform 118 may be employed, using an XOR operation for example. These transforms may be coded as Program Block 2 of PCA 26.

The final state of the last CA may be the encrypted value of a set of code-book indices originally loaded in PCA 26 in successive steps. The encrypted values of the code-book indices may be collected in output block 46 for transmission as encompressed file 48.

Additional details for the above encryption process are described in a paper entitled “A Cryptosystem Designed for Embedded System Security,” Subhayan Sen, I. Hossain, K. Islam, D. Roy Chaudhuri, P. Pal Chaudhuri, IEEE VLSI Design conference, New Delhi, India, January 2003, which is hereby incorporated by reference.

In one embodiment, the D'encompression program is similar to Program Block 2 except that the program steps are reversed. As a result, as indicated by arrow 122 in FIG. 7, the steps of Program Block 2 are performed in reverse when the D'encompression program executes. As such, the encrypted code-book indices loaded into PCA 62 may be decrypted when the D'encompression program is executed. As described in section I(F), the decrypted indices may be used to retrieve the code-vectors from the code-book stored in code-book memory 72 to create D'encompressed file 76.

III. Algorithms for Generation of Encompression and D'encompression Programs

This section describes the algorithms for generation of Encompression and D'encompression programs employed in the CE and DE algorithms described above. In one embodiment, the Encompression and D'encompression programs include a sequence of steps with each step specifying one or more of the following three fields:

Field 1: A CA rule vector that specifies the CA rule with which PCA 26 or PCA 62 is configured;

Field 2: The number of cycles PCA 26 or PCA 62 is operated (i.e. configured with the CA rule vector of Field 1); and

Field 3: An optional field that stores a tag that may be used to initialize a specified set of CA cells and control the Encompression and D'encompression processes implemented by the Encompression module 20 and D'encompression module 24.

As described above, for each class of input data file, different Encompression and D'encompression programs may be generated. The algorithms for generation of the Encompression and D'encompression programs used in Encompression module 20 and D'encompression module 24 are described below.

For a particular set of sample data files on which the Encompression process is to be implemented, the following steps may be executed to generate the Encompression and D'encompression programs:

Step 1: Generate a representative training set for the file type on which the Encompression process is to be implemented.

Step 2: Identify one or more vector sizes (e.g., 4×4, 8×8, or 16×16 pixel blocks on image files), so that in the representative training set of input file type, vectors may be clustered in a minimum number of clusters and the difference between any two members in a cluster is minimal.

Step 3: Generate a code-book with code-vectors (code-vectors may also be referred to as “code-words”), each code-vector representing the centroid of a cluster.

Step 4: (1) Design an MACA-based multi-stage two-class classifier for a binary search in the code-book. In one embodiment, multiple MACAS are generated to search the code-book. The binary tree of each of the MACAs may generate the index of an entry in the code-book. The MACA rule vectors may be organized as a program for Encompression, which may form Program Block 1.

(2) Program Block 2 may be generated from linear, additive, and non-linear CA-based transforms for data security. The CA rule vectors and the number of cycles each is operated may be organized to generate Program Block 2. In one embodiment, the reverse order implementation of Program Block 2 constitutes the D'encompression program.

Step 5: Organize the Encompression and D'encompression programs for a desired flow of control exercised by control block 34 and control block 66 for Encompression and D'encompression, respectively.

Section 4 of the paper entitled “A Pipeline Architecture for Encompression (Encryption+Compression) Technology,” details a particular example implementation of the above-described algorithm for a static image of the human face.

Section 4 of the paper entitled “A Cryptosystem Designed for Embedded System Security,” details various types of example CA-based transforms employed to generate Program Block 2 of step 4 of the above-described algorithm.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method of encompressing a data stream, comprising:
compressing vectors from the data stream using one or more Multiple Attractor Cellular Automatas (MACAs); and
encrypting the compressed vectors using multiple Cellular Automata (CA) transforms.

2. The method of claim 1, wherein compressing the vectors and encrypting the compressed vectors is a single integrated process implemented with a program executed on a Programmable CA (PCA).

3. The method of claim 1, further comprising generating a code-book, the one or more MACAs operable to perform binary searches in the code-book to compress the vectors from the data stream.

4. The method of claim 3, further comprising storing the code-book using one or more multi-stage MACA-based two class classifiers which act as implicit memory to store the code-book.

5. The method of claim 1, wherein compressing the vectors from the data stream using one or more MACAs comprises deriving code-book indices for the vectors.

6. The method of claim 1, wherein encrypting the compressed vectors using multiple CA transforms comprises using a series of reversible transforms that use one or more of linear CA, additive CA, and non-linear CA configured in a PCA at one or more different time steps.

7. The method of claim 6, comprising encrypting the compressed vectors using four levels of CA transforms.

8. The method of claim 7, wherein encrypting the compressed vectors using multiple CA transforms comprises using one or more of linear transformations, affine transformations, and non-affine transformations.

9. The method of claim 1, further comprising transmitting the encompressed data across a communications link.

10. The method of claim 9, further comprising decrypting the transmitted encompressed data using multiple CA transforms.

11. Logic encoded in media for encompressing a data stream, when executed the logic operable to:
compress vectors from the data stream using one or more Multiple Attractor Cellular Automatas (MACAs); and
encrypt the compressed vectors using multiple Cellular Automata (CA) transforms.

12. The logic of claim 11, operable to compress the vectors and encrypt the compressed vectors in a single integrated process implemented with a Programmable CA (PCA).

13. The logic of claim 11, further operable to generate a code-book, the one or more MACAs operable to perform binary searches in the code-book to compress the vectors from the data stream.

14. The logic of claim 11, further operable to store the code-book using one or more multi-stage MACA-based two class classifiers which act as implicit memory to store the code-book.

15. The logic of claim 11, operable to compress the vectors from the data stream using one or more MACAs by deriving code-book indices for the vectors.

16. The logic of claim 11, operable to encrypt the compressed vectors using multiple CA transforms by using a series of reversible transforms that use one or more of linear CA, additive CA, and non-linear CA configured in a PCA at one or more different time steps.

17. The logic of claim 15, operable to encrypting the compressed vectors using four levels of CA transforms.

18. The logic of claim 17, operable to encrypt the compressed vectors using multiple CA transforms by using one or more of linear transformations, affine transformations, and non-affine transformations.

19. The logic of claim 11, further operable to transmit the encompressed data across a communications link.

20. The logic of claim 19, further operable to decrypt the transmitted encompressed data using multiple CA transforms.

21. A system for encompressing a data stream, the system comprising:
a first module operable to compress vectors from the data stream using one or more Multiple Attractor Cellular Automatas (MACAs); and
a second module operable to encrypt the compressed vectors using multiple Cellular Automata (CA) transforms.

22. The system of claim 21, wherein the first module is operable to compress the vectors and the second module is operable to encrypt the compressed vectors in a single integrated process implemented with a Programmable CA (PCA).

23. The system of claim 21, wherein the first module is further operable to generate a code-book, the one or more MACAs operable to perform binary searches in the code-book to compress the vectors from the data stream.

24. The system of claim 21, wherein the first module is further operable to store the code-book using one or more multi-stage MACA-based two class classifiers which act as implicit memory to store the code-book.

25. The system of claim 21, wherein the first module is operable to compress the vectors from the data stream using one or more MACAs by deriving code-book indices for the vectors.

26. The system of claim 21, wherein the second module is operable to encrypt the compressed vectors using multiple CA transforms by using a series of reversible transforms that use one or more of linear CA, additive CA, and non-linear CA configured in a PCA at one or more different time steps.

27. The system of claim 26, wherein the second module is operable to encrypt the compressed vectors using four levels of CA transforms.

28. The system of claim 27, wherein the second module is operable to encrypt the compressed vectors using multiple CA transforms by using one or more of linear transformations, affine transformations, and non-affine transformations.

29. The system of claim 21, further operable to transmit the encompressed data across a communications link.

30. The system of claim 27, further operable to decrypt the transmitted encompressed data using multiple CA transforms.

31. A system for encompressing a data stream, comprising:
a programmable CA (PCA) operable to receive vectors from the data stream;
a program memory operable to communicate with the PCA;
an index memory operable to communicate with the PCA; and
an index register operable to communicate with the index memory;
the program memory storing a program operable to:
configure the PCA with a rule vector of a CA; and
enable the PCA to be run through a number of cycles controlled by the program, a resulting Pseudo-Exhaustive Field (PEF) value being directed to address the index memory;
the index memory providing values to the index register, enabling a code-book index to be generated for an input vector loaded into the PCA.

32. The system of claim 31, wherein the index memory comprises a 1-bit index memory, the resulting value directed to the index memory comprising a PEF of an attractor state of the CA.

33. A method for encompressing a data stream, comprising:
receiving at a programmable CA (PCA) vectors from the data stream;
using a program stored in a program memory in communication with the PCA:
configuring the PCA with a rule vector of a CA; and
enabling the PCA to be run through a number of cycles controlled by the program, a resulting Pseudo-Exhaustive Field (PEF) value being directed to address an index memory in communication with the PCA, the index memory providing values to an index register in communication with the index memory, enabling a code-book index to be generated for an input vector loaded into the PCA.

34. The method of claim 33, wherein:
the index memory comprises a 1-bit index memory; and
the resulting value comprises a PEF of an attractor state of the CA.
